(19) United States
(12) Patent Application Publication
(10) Pub. No.: US 2008/0130941 A1
(43) Pub. Date: Jun. 5, 2008

(54) Watermark detection device

(76) Inventor: Katsuhiko Araki, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/821,240

(22) Filed: Jun. 22, 2007

(30) Foreign Application Priority Data
Nov. 30, 2006 (JP) 2006-325017

(51) Int. Cl. G06K 9/00

(52) U.S. Cl. 382/100

(57) ABSTRACT

According to one embodiment, a watermark detection device includes: a decoding unit comprising a plurality of decoders that respectively decode a plurality of data streams, at least one of which a watermark is superimposed on; a mixer that mixes the decoded data streams; a controller that specifies one of the decoded data streams; and a detection unit that detects the watermark from the specified one of the decoded data streams.

### CROSS-REFERENCE TO RELATED APPLICATIONS

This application is based upon and claims the benefit of priority from Japanese Patent Application No. 2006-325017 filed on Nov. 30, 2006, the entire contents of which are incorporated herein by reference.

### BACKGROUND

1. Field

One embodiment of the invention relates to a technique to detect a watermark superimposed on a data stream such as an audio stream.

2. Description of the Related Art

In recent years, an electronic watermark technology of superimposing specific information on audio content has been widely used for preventing secondary use of unauthorized duplication of, tampering with, etc., audio content converted into digital data. The electronic watermark (simply, watermark) refers to information superimposed on any desired area of digital data as the main body of a copyrighted work, namely, content. Information to be superimposed as a watermark includes information called copy generation information. The copy generation information is, for example, “copy free” meaning that the content (data) can be freely copied, “one copy” meaning that the content (data) can be copied only one generation, “no more copy” meaning that the content (data) can be copied no more, “never copy” meaning that the content (data) cannot be copied at all, etc. For example, if the watermark is “never copy,” a recorder prohibits record on a record medium.

The Japanese Patent Application Publication (KOKAI) No. 2003-208187 discloses an information processing apparatus making it possible to reduce computation required for superimposing a watermark on content, detecting a watermark superimposed on content, changing the detected watermark, etc.

Recently, an HD DVD provided by drastically improving the record capacity and function of a former DVD has been developed and has begun to become widespread on the market. In the HD DVD-Video standard, Advanced Content can be stored in addition to information of video, audio data, etc., contained in a former DVD. The Advanced Content includes various application programs of a game, etc., a network connection function, subvideo, etc., for example.

A plurality of audio streams of Main, Sub, Effect, etc., are defined in the format of the advanced content, etc., of the HD DVD and can be mixed for playback.

In the case as described above, there may be possible that the watermark indicating copyright protection information, etc., may be superimposed on any other audio stream than the Main audio stream. Although a watermark can be detected after mixing processing depending on the watermark detection algorithm, if a watermark is detected for the stream before execution of mixing, the watermark detection accuracy is enhanced. On the other hand, if watermark detection units are provided for respective audio streams, the mode becomes disadvantageous in the cost and the implementation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram to show the configuration of a watermark detection device according to a first embodiment of the present invention;

FIG. 2 is an exemplary flowchart to show the operation according to the first embodiment;

FIG. 3 is an exemplary block diagram to show the configuration of a watermark detection device according to of a second embodiment of the present invention;

FIG. 4 is an exemplary drawing to show a memory mapping of a memory;

FIG. 5 is an exemplary flowchart to show the operation according to the second embodiment;

FIG. 6 is an exemplary block diagram to show the configuration of a watermark detection device according to a third embodiment of the present invention; and

FIG. 7 is an exemplary flowchart to show the operation according to the third embodiment.

### DETAILED DESCRIPTION

Various embodiments according to the invention will be described hereinafter with reference to the accompanying drawings. In general, according to one embodiment of the invention, a watermark detection device includes: a decoding unit comprising a plurality of decoders that respectively decode a plurality of data streams, at least one of which a watermark is superimposed on; a mixer that mixes the decoded data streams; a controller that specifies one of the decoded data streams; and a detection unit that detects the watermark from the specified one of the decoded data streams.

### First Embodiment

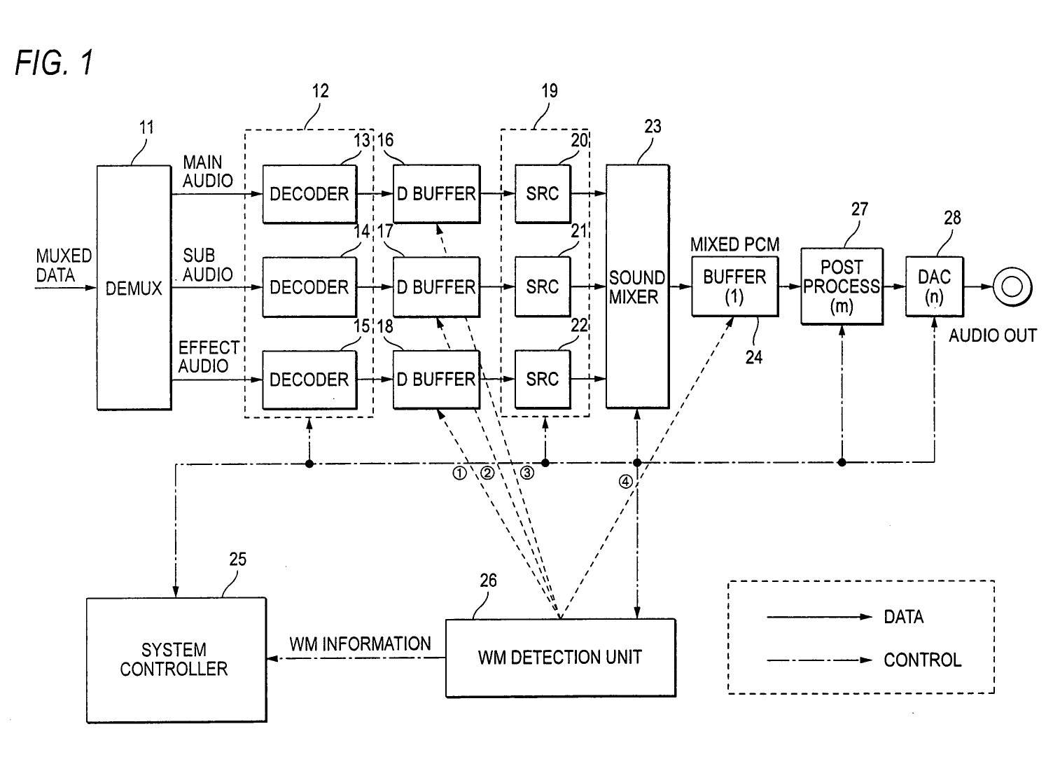

FIG. 1 is an exemplary block diagram to show the configuration of a watermark detection device according to a first embodiment of the present invention. The watermark detection device is applied to a playback apparatus such as an HD DVD player, or example, and detects a watermark (WM: Copyright protection information, etc.,) contained in a playback signal.

A DEMUX (demultiplexer) unit 11 demultiplexes multiplexed coded stream data of audio, video, etc., such as VOB data into respective streams (main audio stream, subaudio stream, and effect audio stream). The multiplexed coded stream data is HD DVD playback data, for example. The case where the multiplexed coded stream contains a main audio stream, a subaudio stream, and an effect audio stream will be discussed, but the invention is not limited to this case and can also be applied to the case where the multiplexed coded stream contains other audio streams such as right and left channel audio streams of stereo. Further, the invention can be applied not only to the audio streams, but also to video streams.

A decoder unit 12 includes decoders 13 to 15 that decodes compressed audio bit streams. The decoder 13 decodes the main audio stream, the decoder 14 decodes the subaudio stream, and the decoder 15 decodes the effect audio stream.

Decoder output buffers (D Buffers) 16 to 18 respectively store the audio data (main audio stream, subaudio stream, and effect audio stream) decoded by the decoder unit 12 for a predetermined length of time. The decoder output buffers 16 to 18 are used to synchronize processing at the preceding stage (here, decode processing) and processing at the following stage (here, SRC processing) with each other.

An SRC (sample rate converter) unit 19 includes SRCs 20 to 22 that respectively change the sampling rates of the decoded audio streams. The SRC unit 19 is used to set the sampling rates of the audio streams to the same sampling rate or execute over or down sampling before mixing.

A mixer (Sound Mixer) unit 23 mixes the decoded audio streams in accordance with a coefficient (gain) specified by a system controller 25.

A buffer unit 24 stores the audio data output from the mixer unit 23 for a predetermined length of time.

A post-process unit 27 performs speaker management and various types of audio effect processing for the audio data output from the buffer unit 24. A DAC unit 28 converts digital audio data provided by the post-process unit 27 into an analog signal.

A system controller 25 totally controls the system of an HD DVD player, etc. A watermark detection unit 26 detects watermark information superimposed on the audio data and sends the detected watermark to the system controller 25.

A watermark detection method according to the first embodiment will be discussed. In the embodiment, the case where the invention is applied to an HD DVD player will be discussed. As shown in FIG. 1, the watermark detection unit 26 can detect a watermark at the following stages of the audio stream decoders 13 to 15 and at the following stage of the audio stream mixer 23.

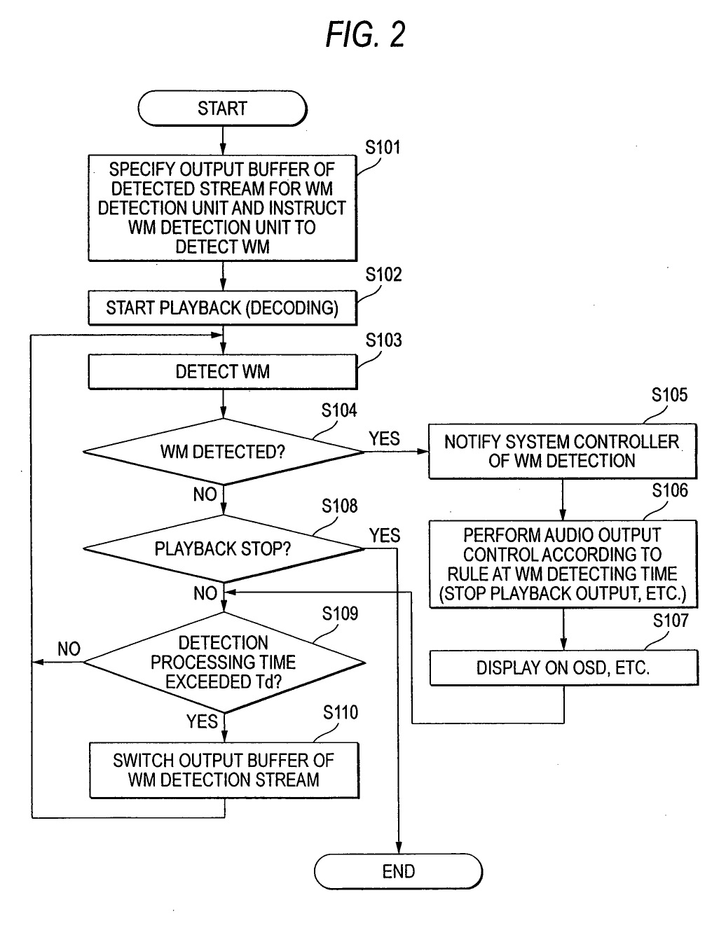

FIG. 2 is an exemplary flowchart to show the operation of the watermark detection device in FIG. 1.

In the embodiment, the case where a watermark is detected from the audio streams stored in the buffers 16 to 18. However, the system controller 25 uses the watermark detection unit 26 to detect a watermark from the audio streams stored in one or more of the buffers 16 to 18 and 24.

First, to play back a disk, the system controller 25 specifies a buffer for a stream to be detected for the watermark detection unit 26 and instructs the watermark detection unit 26 to detect a watermark (S101) and starts to play back a disk (S102). Here, the buffer 16 is specified.

The watermark detection unit 26 starts to detect a watermark in the main audio stream input to the buffer 16 in response to the instruction of the system controller 25 (S103). If the watermark detection unit 26 detects a watermark in the target stream, the watermark detection unit 26 notifies the system controller 25 of detection of the watermark in an interrupting manner, etc., (S105).

If the watermark detection notification is input from the watermark detection unit 26, the system controller 25 controls audio output according to a predetermined rule of watermark detection (S106). The control of the audio output includes playback output stop processing if an audio stream is recorded. The fact that playback output is stopped in response to the watermark detection is displayed using OSD, etc., (S107).

On the other hand, if no watermark detection notification is input from the watermark detection unit 26 (NO at S104), the system controller 25 determines whether or not a playback stop command is given from an operation unit (not shown) (S108). If a playback stop command is not given, the system controller 25 determines whether or not the elapsed time of the watermark detection processing in the buffer where a watermark is being detected at present exceeds a predetermined elapsed time Td (S109). If the elapsed time of the watermark detection processing exceeds the predetermined elapsed time Td, the system controller 25 specifies the buffer 17 for the watermark detection unit 26 and instructs the watermark detection unit 26 to switch the buffer where a watermark is to be detected (S110).

Upon reception of the buffer switching instruction, the watermark detection unit 26 starts watermark detection processing for the next buffer (here, the buffer 17). After this, blocks S103 to S110 are repeated. The system controller 25 thus uses the watermark detection unit 26 to detect a watermark in the buffers 16 to 18 as time division processing while a disk is being played back.

When the number of streams where a watermark is to be detected is n and the number of the watermark detection units is one, the following relation has to be satisfied:

T>n(Td+tc)

T>nTd+(n−1)Tc+Tn+Te

where

Td: Watermark detection time (see S109),

Tc: Detection stream switching time (required time at S110),

Tn: Detection notification time (required time at S105),

Te: Processing time at watermark detecting time (required time at S106),

T: Watermark processing time.

The watermark processing time T is the detection required time (grace time) of a watermark superimposed stream defined by a standard; for example, the time is about one minute.

In the first embodiment, the system controller 25 first specifies only the output buffer 16 for the watermark detection unit 26 at S101, but the output buffers 16 to 18 may be specified. In this case, checking the detection processing time at block S109 and output buffer switching at block S110 are executed only in the watermark detection unit 26. The output buffer specification method and the output buffer switching method can be easily changed as the program of the system controller 25 is changed.

As described above, according to the first embodiment of the invention, the audio stream where a watermark is to be detected can be determined by specifying the decoder output buffer and a watermark can be detected for any desired audio stream using a single watermark detection unit or a smaller number of watermark detection units than the number of streams in a time-division manner.

### Second Embodiment

An System on a Chip (SOC) can be a design technique which will become the mainstream of an integrated circuit in the future. The SOC is a design technique of an integrated circuit where required functions (system) are integrated on one semiconductor chip. For the SOC, a unified memory system, etc., may be used for cost reduction of the system. In the unified memory system, the main memory of a system is used as a data buffer.

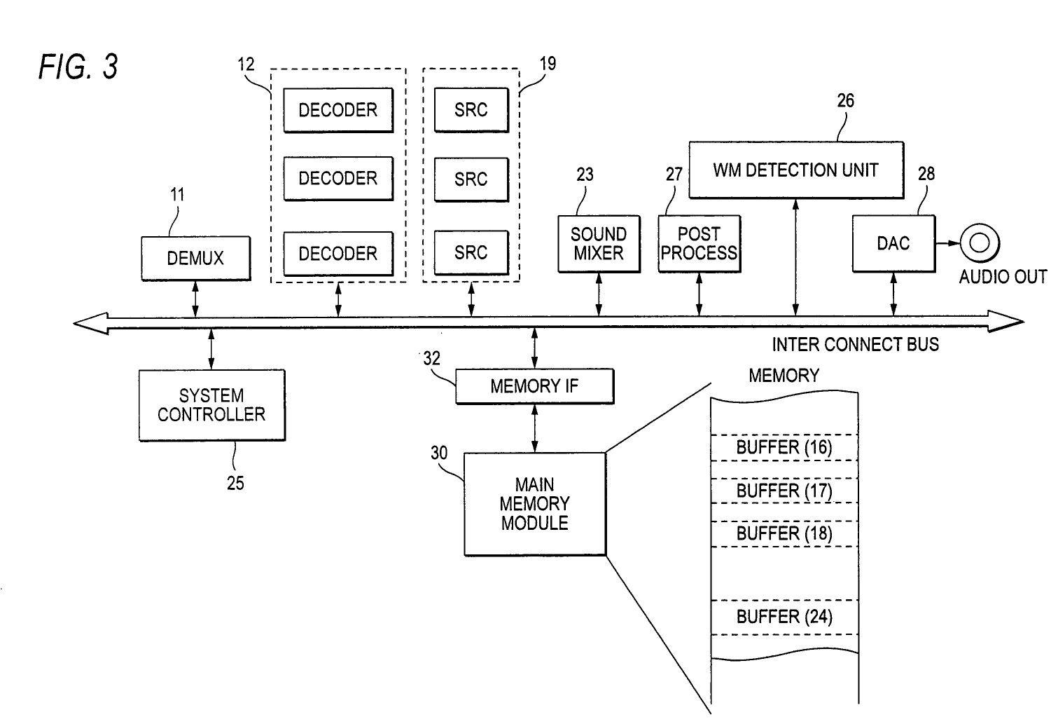

FIG. 3 is an exemplary block diagram to show the configuration a watermark detection device according to a second embodiment of the present invention. Components identical with those previously described with reference to FIG. 1 in the first embodiment are denoted by the same reference numerals in FIG. 3 and will not be discussed again.

This configuration is a configuration wherein all functional modules in an SOC are connected to an internal bus as a technique recently generally often used in decoder SOC etc. A memory module connected to the internal bus is shared by other modules. The watermark detection device differs from that of the first embodiment in that a decoder unit 12, an SRC unit 19, a mixer 23, a post-process unit 27, and a DAC unit 28 are connected to a bus 32 and memory (RAM) is connected to the bus 32.

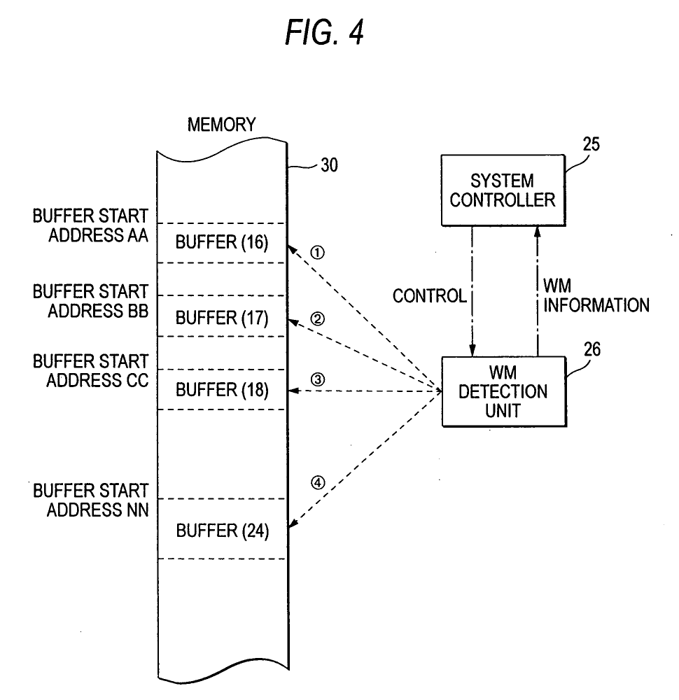

FIG. 4 is an exemplary drawing to show a memory mapping of the memory 30. Memory areas are arranged in the memory 30 as audio stream buffers for streams. A system controller 25 can specify an address pointer to the memory area storing the audio stream buffer where a watermark is to be detected for a watermark detection unit 26, thereby switching a watermark detection stream. The address pointer is the start address of each audio stream buffer, for example.

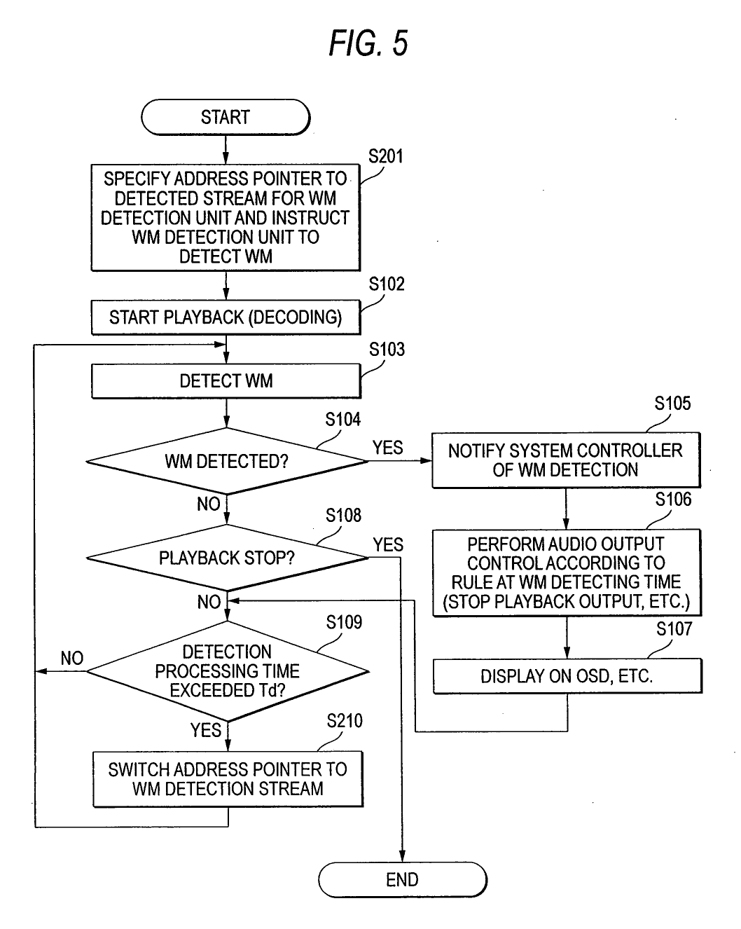

FIG. 5 is an exemplary flowchart to show the operation according to the second embodiment. The flowchart is similar to that of FIG. 2 in the first embodiment; they are different in blocks S101 and S110. That is, the “output buffer” at blocks S101 and S110 in the first embodiment is changed to an “address pointer” at blocks S201 and S210 in the second embodiment corresponding to blocks S101 and S110. Only an address pointer AA (see FIG. 4) may be specified or address pointers AA to CC may be specified for the watermark detection unit 26 at block S201 as with the first embodiment. In this case, checking the detection processing time at block S109 and address pointer switching at block S210 can be executed only in the watermark detection unit 26.

As described above, according to the second embodiment of the invention, the audio stream where a watermark is to be detected can be determined by specifying the address pointer to the memory 30 and a watermark can be detected for any desired audio stream using a single watermark detection unit or a smaller number of watermark detection units than the number of streams in a time-division manner.

### Third Embodiment

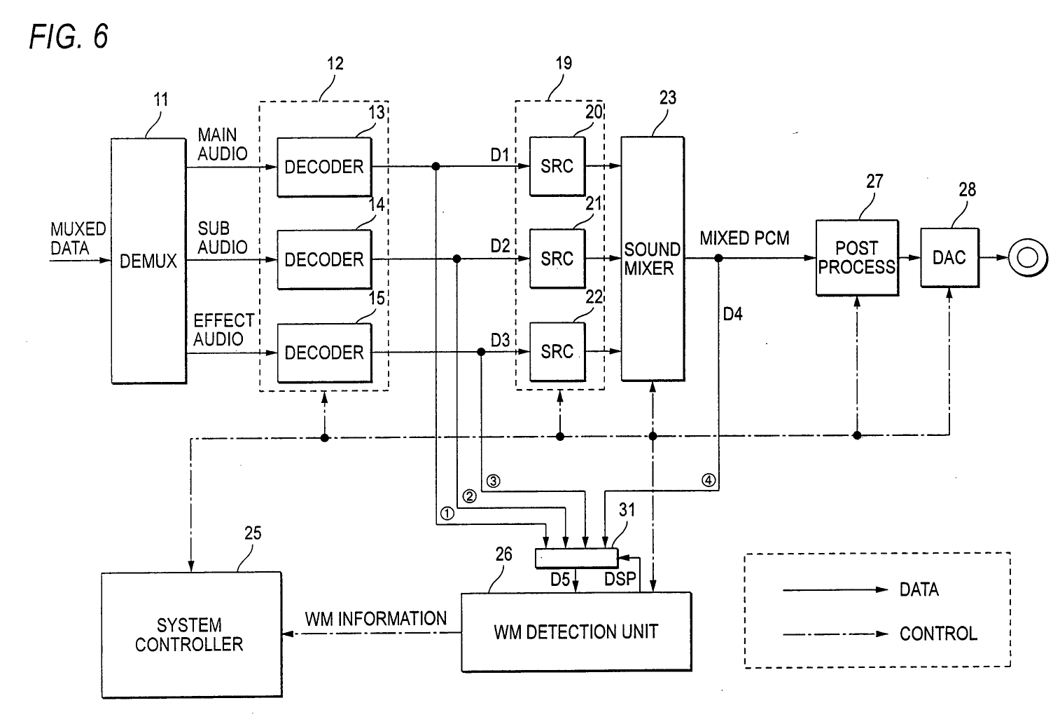

FIG. 6 is an exemplary block diagram to show the configuration of a watermark detection device according to a third embodiment of the present invention. Components identical with those previously described with reference to FIG. 1 in the first embodiment are denoted by the same reference numerals in FIG. 6 and will not be discussed again.

In the third embodiment, output terminals of decoders 13 to 15 are connected to input terminals of SRCs 20 to 22 and a bus selector 31 through data buses D1 to D3. An output terminal of the mixer 23 is connected to a post-process unit 27 and the bus selector 31 through a data bus D4. The bus selector 31 selects one of the data buses D1 to D4 in response to a data bus selection signal DPS from a watermark detection unit 26 and supplies a signal on the selected data bus to the watermark detection unit 26 through a data bus D5.

In the third embodiment, a system controller 25 specifies a data bus for the watermark detection unit 26, thereby switching an audio stream where a watermark is to be detected.

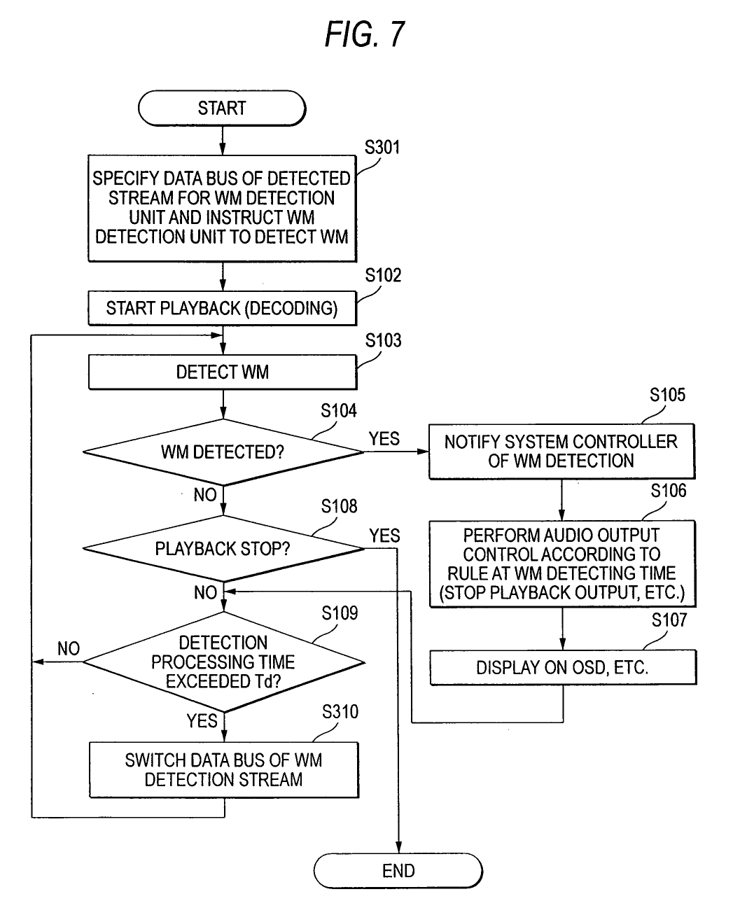

FIG. 7 is an exemplary flowchart to show the operation according to the third embodiment. The flowchart is similar to that of FIG. 2 in the first embodiment; they are different in blocks S101 and S110. That is, the “output buffer” at blocks S101 and S110 in the first embodiment is changed to a “data bus” at blocks S301 and S310 in the third embodiment corresponding to blocks S101 and S110. Only the data bus D1 (see FIG. 6) may be specified or the data buses D1 to D3 may be specified for the watermark detection unit 26 at block S301 as with the first embodiment. In this case, checking the detection processing time at block S309 and data bus switching at block S310 can be executed only in the watermark detection unit 26.

As described above, according to the third embodiment of the invention, it is made possible to determine the audio stream where a watermark is to be detected by specifying one or more of the output data buses of the decoders 13 to 15 and the mixer 23 and it is made possible to detect a watermark for any desired audio stream using a single watermark detection unit or a smaller number of watermark detection units than the number of streams in a time-division manner.

### MODIFIED EXAMPLE

The system according to the invention as described above is used, whereby the stream where a watermark is to be detected can be changed according to the format (standard). In an optical disk recording audio and/or video content, the record area is roughly divided into a management area and a data area. The data format of the content recorded on the disk is described in the management area.

In the example, a system controller 25 reads the management area of the disk and determines the data format of the disk from information included in the management area. The system controller 25 determines the stream where a watermark is to be detected according to the determined format and uses a watermark detection unit 26 to detect a watermark in the stream. Therefore, if the stream on which a watermark is superimposed is determined corresponding to the format, it is made possible to reliably and moreover easily detect a watermark according to the modified example.

As described above, according to the embodiments, it is made possible to switch a watermark detection stream in a plurality of streams. It is made possible to detect a watermark in a plurality of streams at the same time by a smaller number of watermark detection units than the number of streams where a watermark is to be detected. Further, it is made possible to change a watermark detection stream according to the format (standard).

A watermark is detected on one or more audio streams responsive to the system or the format using a single watermark detection unit or a smaller number of watermark detection units than the number of streams, so that the cost and the implementation size of the device can be reduced.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A watermark detection device comprising:
a decoding unit comprising a plurality of decoders that respectively decode a plurality of data streams, at least one of which a watermark is superimposed on;
a mixer that mixes the decoded data streams;
a controller that specifies one of the decoded data streams; and
a detection unit that detects the watermark from the specified one of the decoded data streams.

2. The watermark detection device according to claim 1,
wherein the controller controls the detection unit to detect the watermark from the decoded data streams in a time-division manner.

3. The watermark detection device according to claim 1, further comprising a plurality of buffers including:
a plurality of first buffers that respectively, temporarily store the decoded data streams; and
a second buffer that temporarily stores the mixed, decoded data streams,
wherein the controller specifies one of the buffers to specify the one of the decoded data streams, and
wherein the detection unit detects the watermark from the decoded data stream stored in the specified one of the buffers.

4. The watermark detection device according to claim 1, further comprising a memory comprising a plurality of memory areas including:
a plurality of first memory areas that respectively store the decoded data streams; and
a second memory area that stores the mixed, decoded data streams,
wherein the controller specifies a start address of one of the memory areas to specifies the one of the decoded data streams, and
wherein the detection unit reads a data stream stored in one of the memory areas starting at the specified start address to detect the watermark from the decoded data stream stored in the one of the memory areas.

5. The watermark detection device according to claim 1, further comprising a selection unit that selects the one of the decoded data streams specified by the controller and that provides the selected one of the decoded data streams to the detection unit,
wherein the detection unit detects the watermark from the decoded data stream provided by the selection unit.

6. The watermark detection device according to claim 1,
wherein the plurality of data streams inputted to the decoding unit include playback signals of an optical disk and the controller specifies the one of the decoded data streams according to a format of a data stored on the optical disk.

7. The watermark detection device according to claim 1,
wherein the controller determines whether or not a process time for detecting the watermark from the specified one of the decoded data streams exceeds a predetermined time, and
wherein, when it is determined that the process time exceeds the predetermined time, the controller specifies another one of the decoded data streams and the detection unit detects the watermark from the specified other one of the decoded data streams.

8. A watermark detection device comprising:
a plurality of decoders that respectively decode a plurality of data streams;
a mixer that mixes the decoded data streams;
a post-process unit that processes the mixed, decoded data streams;
a controller that specifies one of the decoded data streams; and
a detection unit that detects a watermark from the specified one of the decoded data streams and provides information about the watermark to the controller,
wherein, when the controller receives the information about the watermark, the controller controls the post-process unit based on the information.

9. A watermark detection device comprising:
a memory;
a processor provided to be accessible to the memory, the processor being operable to perform a process comprising:
decoding a plurality of data streams;
mixing the decoded data streams;
specifying one of the decoded data streams; and
detecting a watermark from the specified one of the decoded data steams.

10. The watermark detection device according to claim 9 further comprising;
specifying another one of the data streams when the watermark is not detected from the specified one of the decoded data streams within a predetermined time; and
detecting a watermark from the specified other one of the decoded data streams.
